(19) United States
(12) Patent Application Publication
(10) Pub. No.: US 2021/0364313 A1
(43) Pub. Date: Nov. 25, 2021

(54) MAPPING METHOD AND DEVICE OF MAP ENGINE, TERMINAL DEVICE, AND STORAGE MEDIUM

(71) Applicant: BOE TECHNOLOGY GROUP CO., LTD., Beijing (CN)

(72) Inventor: Yonggui YANG, Beijing (CN)

(21) Appl. No.: 16/605,933

(22) PCT Filed: May 17, 2019
(86) PCT No.: PCT/CN2019/087426

§ 371 Date: Oct. 17, 2019

(30) Foreign Application Priority Data
May 21, 2018 (CN) 201810488063.4

(51) Int. Cl. G01C 21/36; G06F 3/0484

(52) U.S. Cl. CPC G01C 21/3664; G06F 3/04845; G01C 21/3676

(57) ABSTRACT

A mapping method of a map engine, a mapping device of a map engine, a terminal device, and a storage medium are provided. The mapping method of the map engine includes: receiving an instruction of a user; and performing, according to the instruction of the user, a mapping operation corresponding to the instruction of the user in a drawing process of a surface view. The map engine includes a map engine main process and the drawing process of the surface view.

The present application claims priority of Chinese Patent Application No. 201810488063.4, filed on May 21, 2018, the disclosure of which is incorporated herein by reference in its entirety as part of the present application.

### TECHNICAL FIELD

Embodiments of the present disclosure relate to a mapping method of a map engine, a mapping device of a map engine, a terminal device, and a storage medium.

### BACKGROUND

With continuous development of geographic information technologies, map engines are more and more widely applied in many fields such as navigation, personal consumption, and the like. The map engine can perform personalized mapping based on user's needs, can perform secondary development based on a map engine service, and plays an important role in people's lives.

### SUMMARY

At least one embodiment of the present disclosure provides a mapping method of a map engine, which comprises: receiving an instruction of a user; and performing, according to the instruction of the user, a mapping operation corresponding to the instruction of the user in a drawing process of a surface view, and the map engine comprises a map engine main process and the drawing process of the surface view.

For example, in the mapping method provided by some embodiments of the present disclosure, according to the instruction of the user, in the drawing process of the surface view, a plurality of layers are used to perform the mapping operation corresponding to the instruction of the user; and the plurality of layers comprises a first layer and a second layer, the second layer is superimposed on the first layer, and a background of a region of the second layer except information points is transparent.

For example, in the mapping method provided by some embodiments of the present disclosure, the instruction of the user is received by the drawing process of the surface view or the map engine main process.

For example, in the mapping method provided by some embodiments of the present disclosure, the instruction of the user comprises one or a combination of several selected from a group comprising a scaling instruction, a translation instruction, a single-click instruction, a drawing instruction, a rotation instruction, and a skewing instruction.

For example, in the mapping method provided by some embodiments of the present disclosure, the instruction of the user is the drawing instruction, performing, according to the instruction of the user, the mapping operation corresponding to the instruction of the user in the drawing process of the surface view comprises: determining, according to a type of a drawing message that is received, that the drawing instruction is an interface drawing instruction or a positioning information drawing instruction; in a case of determining that the drawing instruction is the interface drawing instruction, performing path planning asynchronous drawing on the first layer; and in a case of determining that the drawing instruction is the positioning information drawing instruction, performing positioning asynchronous drawing on the second layer.

For example, in the mapping method provided by some embodiments of the present disclosure, performing the path planning asynchronous drawing on the first layer comprises: calling a path planning algorithm through a user interface calling interface; and performing the path planning asynchronous drawing on the first layer according to the path planning algorithm.

For example, in the mapping method provided by some embodiments of the present disclosure, performing the positioning asynchronous drawing on the second layer comprises: calling a positioning algorithm through a user interface calling interface; and performing the positioning asynchronous drawing on the second layer according to the positioning algorithm.

For example, in the mapping method provided by some embodiments of the present disclosure, the instruction of the user is an enlargement instruction in the scaling instruction, receiving the instruction of the user comprises: in a case of detecting a double-click event of the user, determining that the enlargement instruction is received; and performing, according to the instruction of the user, the mapping operation corresponding to the instruction of the user in the drawing process of the surface view comprises: calculating a scaling ratio of a current map according to a scaling ratio of a map before the double-click event occurs and a preset magnification; and performing a zoom-in operation on the map according to the scaling ratio of the current map.

For example, in the mapping method provided by some embodiments of the present disclosure, the instruction of the user is an enlargement instruction or a reduction instruction in the scaling instruction, receiving the instruction of the user comprises: in a case of detecting a multi-point-touch event of the user, determining that the enlargement instruction or the reduction instruction is received; and performing, according to the instruction of the user, the mapping operation corresponding to the instruction of the user in the drawing process of the surface view comprises: calculating a scaling ratio of a current multi-point-touch event according to a distance between two touch points in a last multi-point-touch event, a scaling ratio of the last multi-point-touch event, and a distance between two touch points in the current multi-point-touch event; and performing a zoom-in operation or a zoom-out operation on a map according to the scaling ratio of the current multi-point-touch event.

For example, in the mapping method provided by some embodiments of the present disclosure, the instruction of the user is the translation instruction, receiving the instruction of the user comprises: in a case of detecting a single-point-drag event of the user, determining that the translation instruction is received; and performing, according to the instruction of the user, the mapping operation corresponding to the instruction of the user in the drawing process of the surface view comprises: calculating a center point of a current map according to a moving distance of a single touch point in the single-point-drag event and a center point of a map before the single-point-drag event occurs; and performing a translation operation on the map according to the center point of the current map.

For example, in the mapping method provided by some embodiments of the present disclosure, performing, according to the instruction of the user, the mapping operation corresponding to the instruction of the user in the drawing process of the surface view comprises: adjusting a position of a map mark according to a change in a center point of a map and a change in a scaling ratio of the map.

For example, in the mapping method provided by some embodiments of the present disclosure, the instruction of the user is the single-click instruction, receiving the instruction of the user comprises: in a case of detecting a single-click event of the user, determining that the single-click instruction is received; performing, according to the instruction of the user, the mapping operation corresponding to the instruction of the user in the drawing process of the surface view comprises: determining whether or not a position of a single touch point in the single-click event is located in a preset region of a map mark; and in a case where the position of the single touch point in the single-click event is located in the preset region of the map mark, displaying a bitmap file of the map mark.

At least one embodiment of the present disclosure provides a mapping device of a map engine, and the mapping device comprises: a receiving unit and a performing unit, the receiving unit is configured to receive an instruction of a user; the performing unit is configured to perform, according to the instruction of the user, a mapping operation corresponding to the instruction of the user in a drawing process of a surface view; and the map engine comprises a map engine main process and the drawing process of the surface view.

For example, in the mapping device provided by some embodiments of the present disclosure, the performing unit is configured to adopt a plurality of layers to perform, according to the instruction of the user, the mapping operation corresponding to the instruction of the user in the drawing process of the surface view, the plurality of layers comprises a first layer and a second layer, the second layer is superimposed on the first layer, and a background of a region of the second layer except information points is transparent.

For example, in the mapping device provided by some embodiments of the present disclosure, the instruction of the user is received by the drawing process of the surface view or the map engine main process.

For example, in the mapping device provided by some embodiments of the present disclosure, the instruction of the user comprises one or a combination of several selected from a group comprising a scaling instruction, a translation instruction, a single-click instruction, a drawing instruction, a rotation instruction, and a skewing instruction.

For example, in the mapping device provided by some embodiments of the present disclosure, the instruction of the user is the drawing instruction, and the performing unit is configured to determine, according to a type of a drawing message received by the receiving unit, that the drawing instruction is an interface drawing instruction or a positioning information drawing instruction, to perform path planning asynchronous drawing on the first layer in a case of determining that the drawing instruction is the interface drawing instruction, and to perform positioning asynchronous drawing on the second layer in a case of determining that the drawing instruction is the positioning information drawing instruction.

For example, in the mapping device provided by some embodiments of the present disclosure, the performing unit performing the path planning asynchronous drawing on the first layer comprises: the performing unit calling a path planning algorithm through a user interface calling interface and performing the path planning asynchronous drawing on the first layer according to the path planning algorithm.

For example, in the mapping device provided by some embodiments of the present disclosure, the performing unit performing the positioning asynchronous drawing on the second layer comprises: the performing unit calling a positioning algorithm through a user interface calling interface and performing the positioning asynchronous drawing on the second layer according to the positioning algorithm.

For example, in the mapping device provided by some embodiments of the present disclosure, the instruction of the user is an enlargement instruction in the scaling instruction, the receiving unit is configured to determine that the enlargement instruction is received in a case of detecting a double-click event of the user, and the performing unit is configured to calculate a scaling ratio of a current map according to a scaling ratio of a map before the double-click event occurs and a preset magnification, and to perform a zoom-in operation on the map according to the scaling ratio of the current map.

For example, in the mapping device provided by some embodiments of the present disclosure, the instruction of the user is an enlargement instruction or a reduction instruction in the scaling instruction, the receiving unit is configured to determine that the enlargement instruction or the reduction instruction is received in a case of detecting a multi-point-touch event of the user, and the performing unit is configured to calculate a scaling ratio of a current multi-point-touch event according to a distance between two touch points in a last multi-point-touch event, a scaling ratio of the last multi-point-touch event, and a distance between two touch points in the current multi-point-touch event, and to perform a zoom-in operation or a zoom-out operation on a map according to the scaling ratio of the current multi-point-touch event.

For example, in the mapping device provided by some embodiments of the present disclosure, the instruction of the user is the translation instruction, the receiving unit is configured to determine that the translation instruction is received in a case of detecting a single-point-drag event of the user, and the performing unit is configured to calculate a center point of a current map according to a moving distance of a single touch point in the single-point-drag event and a center point of a map before the single-point-drag event occurs, and to perform a translation operation on the map according to the center point of the current map.

For example, in the mapping device provided by some embodiments of the present disclosure, the performing unit is configured to adjust a position of a map mark according to a change in a center point of a map and a change in a scaling ratio of the map.

For example, in the mapping device provided by some embodiments of the present disclosure, the instruction of the user is the single-click instruction, the receiving unit is configured to determine that the single-click instruction is received in a case of detecting a single-click event of the user, and the performing unit is configured to determine whether or not a position of a single touch point in the single-click event is located in a preset region of a map mark, and to display a bitmap file of the map mark in a case where the position of the single touch point in the single-click event is located in the preset region of the map mark.

At least one embodiment of the present disclosure provides a terminal device, which comprises: a memory, a processor, and a computer program stored on the memory and being capable of being executed by the processor, and the processor executes the computer program to implement the mapping method of the map engine according to any one of the embodiments of the present disclosure.

At least one embodiment of the present disclosure provides a non-temporary computer readable storage medium on which a computer program is stored, and the computer program is capable of being executed by a processor to implement the mapping method of the map engine according to any one of the embodiments of the present disclosure.

### BRIEF DESCRIPTION OF THE DRAWINGS

In order to clearly illustrate the technical solutions of the embodiments of the disclosure, the drawings of the embodiments will be briefly described in the following; it is obvious that the described drawings are only related to some embodiments of the disclosure and thus are not limitative to the disclosure.

FIG. 1A is a flow chart of a mapping method of a map engine according to some embodiments of the present disclosure;

FIG. 1B is a schematic diagram of an effect after superimposing layers in a mapping method of a map engine according to some embodiments of the present disclosure;

FIG. 2 is a schematic block diagram of a mapping device of a map engine according to some embodiments of the present disclosure;

FIG. 3 is a schematic block diagram of a terminal device according to some embodiments of the present disclosure; and

FIG. 4 is a schematic diagram of a storage medium according to some embodiments of the present disclosure.

### DETAILED DESCRIPTION

The embodiments of the present disclosure are described in detail below, examples of the embodiments are illustrated in the drawings, and the same or similar reference numerals indicate the same or similar components or components having the same or similar functions from first to last. The embodiments described below with reference to the drawings are illustrative, and are intended to explain the present disclosure, but are not to be construed as limiting the present disclosure. Apparently, the described embodiments are just a part but not all of the embodiments of the disclosure. Based on the described embodiments herein, those skilled in the art can obtain other embodiment(s), without any inventive work, which should be within the scope of the disclosure.

In a terminal with a general android system, a map engine is mostly encapsulated in a SDK form, and it is difficult to develop customization functions, which is not conducive to the expansion of functions. For example, for a verification research, functions of the map engine seem very cumbersome, which is not conducive to achieving the expansion of functions as soon as possible to obtain a verification result.

At least one embodiment of the present disclosure provides a mapping method of a map engine, a mapping device of a map engine, a terminal device, and a storage medium, and functions of the map engine can be achieved by inheriting the native surface view (or be called as SurfaceView or surface view), which is simple and practical, has high efficiency, and has strong functional extensibility.

The mapping method of the map engine, the mapping device of the map engine, the terminal device, and the non-temporary computer readable storage medium provided by the embodiments of the present disclosure are described below with reference to the accompanying drawings.

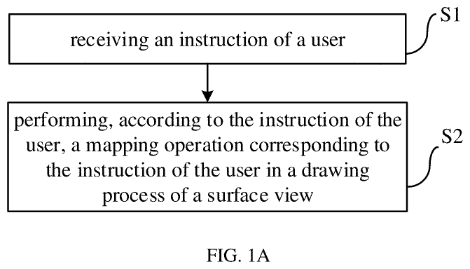

FIG. 1A is a flow chart of a mapping method of a map engine according to some embodiments of the present disclosure. Steps of the mapping method of the map engine provided by some embodiments of the present disclosure are described below with reference to FIG. 1A.

In step S1, an instruction of a user is received.

According to some embodiments of the present disclosure, the instruction of the user may comprise any one or a combination of several selected from following instructions, which comprise: a scaling instruction, a translation instruction, a single-click instruction, a drawing instruction, a rotation instruction, and a skewing instruction. For example, the scaling instruction may comprise an enlargement instruction and a reduction instruction.

For example, in the embodiments of the present disclosure, a map (such as an indoor map) may be in a form of picture and stored in a display terminal (such as a mobile phone, a computer, etc.), and the instruction of the user can be received through a screen (such as a touch screen) of the display terminal. For example, in a case where a finger of the user slides on the screen of the display terminal, it can be determined that the user gives a translation instruction, and the display terminal receives the translation instruction given by the user.

In step S2, according to the instruction of the user, a mapping operation corresponding to the instruction of the user is performed in a drawing process of a surface view (SurfaceView). For example, the map engine comprises a map engine main process and the drawing process of the SurfaceView. For example, the map engine main process is used to achieve functions such as displaying information, controlling to exit or open an application, calling other programs, and the like. For example, the drawing process of the SurfaceView is used to perform the mapping operation.

After receiving different instructions given by the user, the mapping operation corresponding to the instruction of the user can be performed according to the instruction of the user in the drawing process of the SurfaceView, and therefore, the functions of the map engine by inheriting the native SurfaceView are achieved, which is simple and practical, has high efficiency, and has strong functional extensibility. For example, the SurfaceView of the android system has an independent drawing surface, the user interface (UI) drawing can be performed in an independent thread, and therefore, a complex UI drawing can be performed without affecting the response of a main thread of the application to an input of the user, and the SurfaceView of the android system is simple to use and has the characteristic of high efficiency. In the embodiments of the present disclosure, the map engine main process and the drawing process of the SurfaceView are two relatively independent processes, so that the drawing operation and an operation performed by the main process do not affect each other, thereby improving efficiency and increasing a running speed. Other detailed descriptions of the SurfaceView can be referred to the conventional design, which are not described in detail herein.

For example, in the step S2, according to the instruction of the user, in the drawing process of the SurfaceView, a plurality of layers are used to perform the mapping operation corresponding to the instruction of the user. For example, the plurality of layers comprises a first layer and a second layer, the second layer is superimposed on the first layer, and a background of a region of the second layer except information points is transparent. For example, the instruction of the user is received by the drawing process of the SurfaceView, and of course, may also be received by the map engine main process, and the embodiments of the present disclosure are not limited thereto.

According to some embodiments of the present disclosure, the instruction of the user is the drawing instruction. Receiving the instruction of the user comprises: in a case of receiving a drawing message, determining that the drawing instruction is received. Performing, according to the instruction of the user, the mapping operation corresponding to the instruction of the user in the drawing process of the SurfaceView comprises: determining, according to a type of the drawing message that is received, that the drawing instruction is an interface drawing instruction or a positioning information drawing instruction; in a case of determining that the drawing instruction is the interface drawing instruction, performing path planning asynchronous drawing on the first layer; and in a case of determining that the drawing instruction is the positioning information drawing instruction, performing positioning asynchronous drawing on the second layer. The second layer is superimposed on the first layer, and the background of the region of the second layer except the information points is transparent.

For example, a traditional asynchronous thread drawing method is to redraw a map every time a new thread is opened, which not only occupies a large amount of memory, but also cannot perform the corresponding mapping operation in time in a case of receiving the drawing instruction of the user.

Therefore, in the embodiments of the present disclosure, a new DrawThread is opened to handle the drawing event, and two layers, namely a first layer Canvas1 and a second layer Canvas2, are added. For example, the first layer Canvas1 is used for general interface drawing (UI interface drawing), the second layer Canvas2 is used to describe the positioning information, the second layer Canvas2 is superimposed on the first layer Canvas1, and the background of the region of the second layer Canvas2 except the information points is transparent, thereby facilitating the refreshing of the information of the first layer Canvas1. An effect schematic diagram after superimposing layers is illustrated in FIG. 1B. For example, the type of the drawing message can be passed through a Handler every time the re-drawing is required, so as to distinguish whether the drawing message is the interface drawing or the positioning information drawing, and the drawing message is processed by the DrawThread to call the drawing methods corresponding to different layers to perform asynchronous drawing. The mapping method of the map engine provided by the embodiments of the present disclosure can perform the mapping operation corresponding to the instruction of the user in time when receiving the drawing instruction of the user, has high efficiency, can achieve a real-time purpose, and meanwhile, can greatly reduce the occupation space of the memory.

According to some embodiments of the present disclosure, performing the path planning asynchronous drawing on the first layer comprises: calling a path planning algorithm through a user interface (UI) calling interface; and performing the path planning asynchronous drawing on the first layer according to the path planning algorithm.

According to some embodiments of the present disclosure, performing the positioning asynchronous drawing on the second layer comprises: calling a positioning algorithm through a user interface (UI) calling interface; and performing the positioning asynchronous drawing on the second layer according to the positioning algorithm.

For example, all of the above-described path planning algorithm and the positioning algorithm can be implemented in C language, and the JNI mechanism is adopted by android to provide the UI calling interface, thereby implementing the functions of path planning and positioning. For example, the algorithms are encapsulated by using a cross-compiled dynamic library form, on one hand, the portability and security of the algorithms can be ensured, and on the other hand, the UI calling interface is encapsulated directly, the UI calling interface is called in a case where the DrawThread processes the drawing event, the NEON architecture of a mobile terminal can be fully utilized to make up for the insufficiency of the JVM mechanism of the android system, thereby improving the processing efficiency, and achieving the seamless combination of processing the drawing event by the DrawThread and the interface of the algorithm JNI.

Therefore, in a case of determining that the drawing instruction is the interface drawing instruction, the path planning algorithm can be called through the UI calling interface, and the path planning asynchronous drawing can be performed on the first layer Canvas1 according to the path planning algorithm, thereby implementing the path planning function. In a case of determining that the drawing instruction is the positioning information drawing instruction, the positioning algorithm can be called through the UI calling interface, and the positioning asynchronous drawing can be performed on the second layer Canvas2 according to the positioning algorithm, thereby implementing the positioning function.

It should be noted that, in a case of receiving the scaling instruction, the translation instruction, the rotation instruction, and the skewing instruction, which are given by the user, an image operation method provided by the Matrix class can be used to process an image accordingly. For example, the Matrix can be a 3*3 matrix, and the matrix can be used to process the image accordingly. Therefore, in the android system, some simple image operations can be performed by some encapsulated methods, for example, the simple image operations are divided into four types: rotating, scaling, translating, and skewing, each transformation provides three operation modes: first clearing a queue and then adding (set), adding at the end of the queen (post), and inserting at the beginning of the queen (pre), and in addition to translating, the other three operations of the image can specify a center point.

According to some embodiments of the present disclosure, the instruction of the user is the enlargement instruction in the scaling instruction. Receiving the instruction of the user comprises: in a case of detecting a double-click event of the user, determining that the enlargement instruction is received. Performing, according to the instruction of the user, the mapping operation corresponding to the instruction of the user in the drawing process of the SurfaceView comprises: calculating a scaling ratio of a current map according to a scaling ratio of a map before the double-click event occurs and a preset magnification, and performing a zoom-in operation on the map.

For example, in order to achieve enlargement by double-clicking, a member variable lastClickTime can be set in the MyMap class to record the time when the user last clicked on the screen of the display device, for example, a time value of clicking the screen of the display device can be obtained by a getEventTime method of MotionEvent, and the unit of the time value is ms. A difference between the time when the user currently clicks on the screen of the display device and the time when the user last clicks on the screen of the display device can be calculated according to the time when the user last clicks on the screen of the display device, and in a case where the difference is less than a preset time threshold (such as 300 ms), it means that the user continuously clicks on the screen of the display device twice, so it can be determined that the double-click event of the user is detected, thereby determining that the enlargement instruction is received. It should be noted that, in the embodiments of the present disclosure, the preset time threshold is not limited to 300 ms, which may also be other suitable values, and may be modified and reset by the user according to the operation habit, and the embodiments of the present disclosure do not limit the preset time threshold.

After receiving the enlargement instruction of the user, the scaling ratio of the current map can be calculated according to the scaling ratio of the map before the double-click event occurs and the preset magnification. For example, the preset magnification is the magnification of the map based on the scaling ratio before the double-click event occurs each time the user double-clicks on the screen of the display device. The preset magnification can be calibrated according to the actual situation, and can be stored in a storage unit of the display device in advance, so as to be called when the enlargement instruction of the user is received. That is, after receiving the enlargement instruction of the user, the scaling ratio of the map before the double-click event occurs can be obtained, and the preset magnification stored in the storage unit can be called. The scaling ratio of the map before the double-click event occurs is multiplied by the preset magnification to calculate the scaling ratio of the current map, and the map is zoomed in according to the calculated scaling ratio of the current map. Therefore, the function of enlargement by double-clicking can be achieved.

According to some embodiments of the present disclosure, the instruction of the user is the scaling instruction, and the scaling instruction may comprise, for example, the enlargement instruction or the reduction instruction. Receiving the instruction of the user comprises: in a case of detecting a multi-point-touch event of the user, determining that the enlargement instruction or the reduction instruction in the scaling instruction is received. Performing, according to the instruction of the user, the mapping operation corresponding to the instruction of the user in the drawing process of the SurfaceView comprises: calculating a scaling ratio of a current multi-point-touch event according to a distance between two touch points in a last multi-point-touch event, a scaling ratio of the last multi-point-touch event, and a distance between two touch points in the current multi-point-touch event; and performing a zoom-in operation or a zoom-out operation on a map according to the scaling ratio of the current multi-point-touch event.

As a possible implementation manner, the screen of the display device may adopt a capacitive touch screen, and the multi-point-touch event of the user is detected through the capacitive touch screen. In a case where the user (for example, a finger of the user) touches the capacitive touch screen, a capacitance value of a touch point changes, so that a current of the touch point changes. In a case where it is detected that currents of a plurality of touch points change simultaneously, it may be determined that the multi-point-touch event of the user is detected, so that it is determined that the scaling instruction is received. For example, in a case where the user touches the capacitive touch screen through two fingers at the same time, the touch screen can detect that the currents of two touch points change simultaneously, that is, the multi-point-touch event of the user is detected, so that it can be determined that the scaling instruction is received, and the scaling instruction comprises, for example, the enlargement instruction or the reduction instruction.

For example, after receiving the enlargement instruction of the user, distances event.getX (0) and event.getX (1) from the click event to a left edge of a control component (such as the touch screen) can be acquired respectively through getX in the MotionEvent event, and distances event.getY (0) and event.getY (1) from the click event to a top edge (that is, an upper edge) of the control component (such as the touch screen) can be acquired respectively through getY in the MotionEvent event, thereby acquiring coordinates (view coordinates), that is, (event.getX (0), event.getX (1)) and (event.getY (0), event.getY (1)), of the two touch points in the current multi-point-touch event. The distance between the two touch points in the current multi-point-touch event is acquired according to the coordinates of the two touch points in the current multi-point-touch event by the method in MotionEvent.

For example, a variable oldDist can be used to represent the distance between the two touch points in the last multi-point-touch event, a variable oldRate is used to represent the scaling ratio of the last multi-point-touch event, a variable newDist is used to represent the distance between the two touch points in the current multi-point-touch event, and a variable newRate is used to represent the scaling ratio of the current multi-point-touch event. A scaling ratio of the map, that is, newDist/oldDist, based on the scaling ratio of the last multi-point-touch event can be calculated according to the distance oldDist between the two touch points in the last multi-point-touch event and the distance newDist between the two touch points in the current multi-point-touch event, and further, the scaling ratio of the current map mCurrentScale can be calculated, that is, mCurrentScale=oldRate*(newDist/oldDist), namely the scaling ratio of the current multi-point-touch event, and the scaling ratio of the current map, i.e., mCurrentScale=oldRate*(newDist/oldDist), is continuously updated in a case of move in the onTouchEvent method. Therefore, the multi-point-touch scaling function of the map can be implemented. For example, in a case where newDist>oldDist, mCurrentScale>oldRate, so that the zoom-in operation is performed on the map; and in a case where newDist<oldDist, mCurrentScale<oldRate, so that the zoom-out operation is performed on the map.

According to some embodiments of the present disclosure, the instruction of the user is the translation instruction. Receiving the instruction of the user comprises: in a case of detecting a single-point-drag event of the user, determining that the translation instruction is received. Performing, according to the instruction of the user, the mapping operation corresponding to the instruction of the user in the drawing process of the SurfaceView comprises: calculating a center point of a current map according to a moving distance of a single touch point in the single-point-drag event and a center point of a map before the single-point-drag event occurs; and performing a translation operation on the map according to the center point of the current map.

As a possible implementation manner, the capacitive touch screen can be used to detect whether the user touches the capacitive touch screen in a single-point-touch way, and a coordinate of a single touch point is obtained in a case where the single-point touch event of the user is detected. For example, a distance event.getX (2) from the click event to a left edge of a control component can be acquired through getX in the MotionEvent event, and a distance event.getY (2) from the click event to a top edge of the control component can be acquired through getY in the MotionEvent event, that is, the coordinate (event.getX (2), event.getY (2)) of the single touch point is obtained. In a case where the coordinate of the single touch point changes, it can be determined that the single-point-drag event of the user is detected, thereby determining that the translation instruction of the user is received.

After receiving the translation instruction of the user, a moving distance and a moving direction of the single touch point in the single-point-drag event of the user can be obtained by a method in MotionEvent, for example, a moving distance and a moving direction of the finger of the user on the screen of the display device can be obtained, and the coordinate of the center point of the map before the single-point-drag event occurs can be obtained through getX and getY in the MotionEvent event. Because in the single-point-drag event, the moving distance and the moving direction of the single touch point are the same as the moving distance and the moving direction of the center point of the map before the single-point-drag event occurs, and thus, the center point of the current map can be calculated according to the moving distance and the moving direction of the single touch point in the single-point-drag event and the center point of the map before the single-point-drag event occurs, and the coordinate (mapCenter.x, mapCenter.y) of the center point of the current map is updated in real time. For example, a PointF variable mapCenter can be used to represent the coordinate of the center point of the current map on the screen of the display device. The translation operation is performed on the map according to the calculated center point of the current map, and for example, in the draw method, the translation operation is performed on the map by using the Matrix class. Therefore, the translation function of the map can be achieved.

It should be noted that, the various data information in the above embodiments, such as the distance between the two touch points in the last multi-point-touch event, the center point of the map, the scaling ratio of the map, and other data information, can be stored in the storage unit by using a SQLite method and a JSON method, so as to facilitate to being called when the instruction of the user is received. For example, JSON (JavaScript object notation) is a lightweight data representation method, a set of data represented in a JavaScript object can be converted into a string, and then the string can be easily transmitted between functions, or the string is transmitted from a web client to a server-side program in an asynchronous application, JSON format records data through a key-value method, which is very intuitive, and is simpler than XML. SQLite is a lightweight embedded database engine, which can support the SQL language, and can achieve high performance with a small amount of memory.

According to some embodiments of the present disclosure, performing, according to the instruction of the user, the mapping operation corresponding to the instruction of the user in the drawing process of the SurfaceView comprises: adjusting a position of a map mark according to a change in a center point of a map and a change in a scaling ratio of the map.

For example, a MarkObject class can be written to represent the map mark, and the Bitmap object of the map mark, a position of the map mark relative to the entire map, and the processing of a callback event of clicking the map mark are stored under this class. For example, in the MyMap class, a List variable markList is used to record all the map marks that are added.

In a case of receiving the instruction of the user, for example, the enlargement instruction or the reduction instruction of the scaling instruction, or the translation instruction, the center point of the map may change, or the scaling ratio of the map may change, or the center point of the map and the scaling ratio of the map may change simultaneously. In this case, the position of the map mark can be adjusted according to the change in the center point of the map and the change in the scaling ratio of the map. For example, a coordinate of the position of the map mark is calculated according to the coordinate of the center point of the current map, that is, the position of the map mark can change with the double-click event of the user, the multi-point-touch event of the user, the single-point-drag event of the user, and the like. In this case, the position of the map mark can be adjusted according to the change in the center point of the map and the change in the scaling ratio of the map.

According to some embodiments of the present disclosure, the instruction of the user is the single-click instruction. Receiving the instruction of the user comprises: in a case of detecting a single-click event of the user, determining that the single-click instruction is received. Performing, according to the instruction of the user, the mapping operation corresponding to the instruction of the user in the drawing process of the SurfaceView comprises: determining whether or not a position of a single touch point in the single-click event is located in a preset region of a map mark; and in a case where the position of the single touch point in the single-click event is located in the preset region of the map mark, displaying a bitmap file of the map mark.

For example, the click event of the user can be processed by using the map mark. In a case where an up situation occurs in the onTouchEvent method, that is, in a case where the screen of the display device is raised, it indicates that the single-click event of the user is detected, thereby determining that the single-click instruction of the user is received. In this case, it can be determined according to MarkObject in all markList whether or not a current touch point is included in a current marked region, that is, it is determined whether or not the position of the single touch point in the single-click event is located in the preset region of the map mark. In a case where the position of the single touch point is located in the preset region of the map mark, the bitmap file of the map mark can be displayed, so that the user can more fully obtain the information of the region.

In summary, the embodiments of the present disclosure establish, by inheriting the native SurfaceView, a simple and practical map engine that supports the rapid verification of indoor navigation algorithms, which is beneficial to the rapid implementation and verification based on indoor Bluetooth and gyroscope algorithms, and has strong functional extensibility.

In the mapping method of the map engine provided by the embodiments of the present disclosure, the instruction of the user is received, and the mapping operation corresponding to the instruction of the user is performed in the drawing process of the SurfaceView according to the instruction of the user. Thus, the functions of the map engine are achieved by inheriting the native SurfaceView, which is simple and practical, has high efficiency, and has strong functional extensibility.

At least one embodiment of the present disclosure also provides a mapping device of a map engine, the functions of the map engine are achieved by inheriting the native SurfaceView, which is simple and practical, has high efficiency, and has strong functional extensibility.

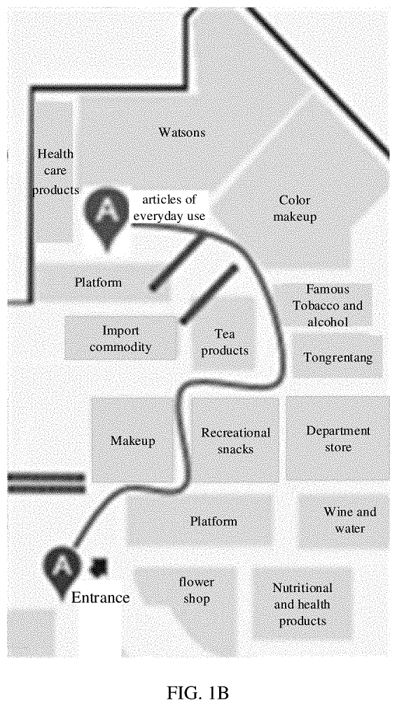

FIG. 2 is a schematic block diagram of a mapping device of a map engine according to some embodiments of the present disclosure. As illustrated in FIG. 2, a mapping device of a map engine provided by the embodiments of the present disclosure may comprise a receiving unit 100 and a performing unit 200.

For example, the receiving unit 100 is configured to receive an instruction of a user; and the performing unit 200 is configured to perform, according to the instruction of the user, a mapping operation corresponding to the instruction of the user in a drawing process of a surface view (SurfaceView). For example, the map engine comprises a map engine main process and the drawing process of the SurfaceView.

For example, the performing unit 200 is configured to adopt a plurality of layers to perform, according to the instruction of the user, the mapping operation corresponding to the instruction of the user in the drawing process of the SurfaceView. For example, the plurality of layers comprises a first layer and a second layer, the second layer is superimposed on the first layer, and a background of a region of the second layer except information points is transparent. For example, the instruction of the user can be received by the drawing process of the SurfaceView, and of course, may also be received by the map engine main process, and the embodiments of the present disclosure are not limited thereto.

According to some embodiments of the present disclosure, the instruction of the user comprises any one or a combination of several selected from following instructions which comprise a scaling instruction, a translation instruction, a single-click instruction, a drawing instruction, a rotation instruction, and a skewing instruction.

According to some embodiments of the present disclosure, the instruction of the user is the drawing instruction; the receiving unit 100 receives the instruction of the user, and for example, the receiving unit 100 is configured to determine that the drawing instruction is received in a case of receiving a drawing message; and the performing unit 200 performs the mapping operation corresponding to the instruction of the user. For example, the performing unit 200 is configured to determine, according to a type of the drawing message received by the receiving unit 100, that the drawing instruction is an interface drawing instruction or a positioning information drawing instruction, to perform path planning asynchronous drawing on the first layer in a case of determining that the drawing instruction is the interface drawing instruction, and to perform positioning asynchronous drawing on the second layer in a case of determining that the drawing instruction is the positioning information drawing instruction. The second layer is superimposed on the first layer, and the background of the region of the second layer except the information points is transparent.

According to some embodiments of the present disclosure, the performing unit 200 performs the path planning asynchronous drawing on the first layer by performing following specific operations. For example, the performing unit 200 calls a path planning algorithm through a user interface (UI) calling interface and performing the path planning asynchronous drawing on the first layer according to the path planning algorithm.

According to some embodiments of the present disclosure, the performing unit 200 performs the positioning asynchronous drawing on the second layer by performing following specific operations. For example, the performing unit 200 calls a positioning algorithm through a user interface (UI) calling interface and performing the positioning asynchronous drawing on the second layer according to the positioning algorithm.

According to some embodiments of the present disclosure, the instruction of the user is the enlargement instruction in the scaling instruction. The receiving unit 100 receives the instruction of the user, and for example, the receiving unit 100 is configured to determine that the enlargement instruction is received in a case of detecting a double-click event of the user. The performing unit 200 performs the mapping operation corresponding to the instruction of the user, and for example, the performing unit 200 is configured to calculate a scaling ratio of a current map according to a scaling ratio of a map before the double-click event occurs and a preset magnification, and to perform a zoom-in operation on the map according to the scaling ratio of the current map.

According to some embodiments of the present disclosure, the instruction of the user is the enlargement instruction or the reduction instruction in the scaling instruction. The receiving unit 100 receives the instruction of the user. For example, the receiving unit 100 is configured to determine that the enlargement instruction or the reduction instruction is received in a case of detecting a multi-point-touch event of the user. The performing unit 200 performs the mapping operation corresponding to the instruction of the user. For example, the performing unit 200 is configured to calculate a scaling ratio of a current multi-point-touch event according to a distance between two touch points in a last multi-point-touch event, a scaling ratio of the last multi-point-touch event, and a distance between two touch points in the current multi-point-touch event, and to perform a zoom-in operation or a zoom-out operation on a map according to the scaling ratio of the current multi-point-touch event.

According to some embodiments of the present disclosure, the instruction of the user is the translation instruction; the receiving unit 100 receives the instruction of the user, and for example, the receiving unit 100 is configured to determine that the translation instruction is received in a case of detecting a single-point-drag event of the user; and the performing unit 200 performs the mapping operation corresponding to the instruction of the user, and for example, the performing unit 200 is configured to calculate a center point of a current map according to a moving distance of a single touch point in the single-point-drag event and a center point of a map before the single-point-drag event occurs, and to perform a translation operation on the map according to the center point of the current map.

According to some embodiments of the present disclosure, the performing unit 200 performs the mapping operation corresponding to the instruction of the user, and for example, the performing unit 200 is configured to adjust a position of a map mark according to a change in a center point of a map and a change in a scaling ratio of the map.

According to some embodiments of the present disclosure, the instruction of the user is the single-click instruction; the receiving unit 100 receives the instruction of the user, and for example, the receiving unit 100 is configured to determine that the single-click instruction is received in a case of detecting a single-click event of the user; and the performing unit 200 performs the mapping operation corresponding to the instruction of the user, and for example, the performing unit 200 is configured to determine whether or not a position of a single touch point in the single-click event is located in a preset region of a map mark, and to display a bitmap file of the map mark in a case where the position of the single touch point in the single-click event is located in the preset region of the map mark.

It should be noted that, details which are not disclosed in the mapping device of the map engine provided by the embodiments of the present disclosure can be referred to the details disclosed in the mapping method of the map engine provided by the embodiments of the present disclosure, and the details are not described herein again.

In the mapping device of the map engine provided by the embodiments of the present disclosure, the receiving unit 100 receives the instruction of the user, and the performing unit 200 performs, according to the instruction of the user, the mapping operation corresponding to the instruction of the user in the drawing process of the SurfaceView. Thus, the functions of the map engine are achieved by inheriting the native SurfaceView, which is simple and practical, has high efficiency, and has strong functional extensibility.

In addition, at least one embodiment of the present disclosure also provides a terminal device. The terminal device comprises: a memory, a processor, and a computer program stored on the memory and being capable of being executed by the processor, and the processor executes the computer program to implement the above-described mapping method of the map engine.

The terminal device provided by the embodiments of the present disclosure achieves the functions of the map engine by inheriting the native SurfaceView, which is simple and practical, has high efficiency, and has strong functional extensibility.

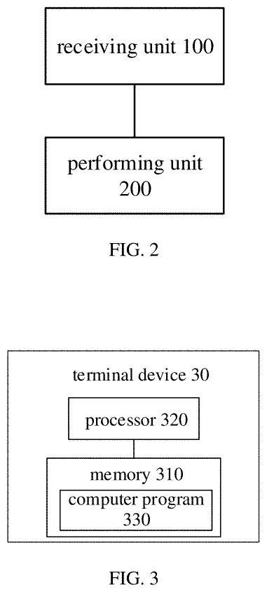

As illustrated in FIG. 3, a terminal device 30 comprises a memory 310, a processor 320, and a computer program 330 stored on the memory 310 and being capable of being executed by the processor 320. In a case where the processor 320 reads the computer program 330 from the memory 310 and executes the computer program 330, the mapping method of the map engine described above can be implemented.

For example, the processor 320 may be a central processing unit (CPU), a digital signal processor (DPS), or other forms of processing unit having data processing capabilities and/or program execution capabilities, such as a field-programmable gate array (FPGA). For example, the central processing unit (CPU) may be an X86 architecture, an ARM architecture, or the like. The processor 320 may be a general purpose processor or a special purpose processor, and can control other components in the terminal device 30 to perform desired functions.

For example, the memory 310 may comprise an arbitrary combination of one or more computer program products. The computer program products may comprise various forms of computer-readable storage media, such as volatile memory and/or non-volatile memory. The volatile memory may comprise, for example, a random access memory (RAM) and/or a cache, or the like. The non-volatile memory may comprise, for example, a read only memory (ROM), a hard disk, an erasable programmable read only memory (EPROM), a portable compact disc-read only memory (CD-ROM), a USB memory, a flash memory, or the like. One or more computer program modules can be stored on the computer-readable storage medium, and the processor 320 may execute the one or more computer program modules to implement various functions of the terminal device 30. Various applications, various data, various data used and/or generated by the applications, and the like, may also be stored in the computer-readable storage medium. The specific functions and the technical effects of the terminal device 30 may be referred to the descriptions of the mapping method of the map engine in the above embodiments, and details are not repeated herein again.

In addition, at least one embodiment of the present disclosure also provides a non-temporary computer readable storage medium, a computer program is stored on the non-temporary computer readable storage medium, and the computer program is executed by a processor to implement the mapping method of the map engine described above.

The non-temporary computer readable storage medium provided by the embodiments of the present disclosure achieves the functions of the map engine by inheriting the native SurfaceView, which is simple and practical, has high efficiency, and has strong functional extensibility.

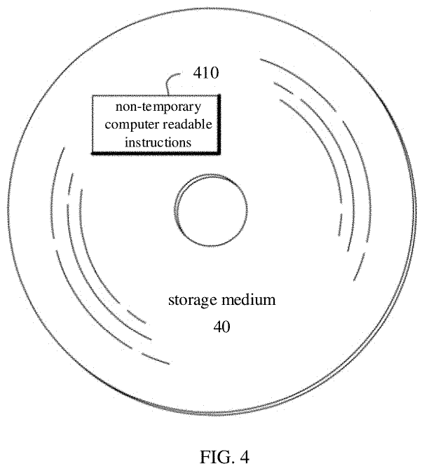

FIG. 4 is a schematic diagram of a storage medium according to some embodiments of the present disclosure. As illustrated in FIG. 4, a storage medium 40 is used to store non-temporary computer readable instructions 410, and the storage medium 40 may be, for example, an optical disk. For example, in a case where the non-temporary computer readable instructions 410 are executed by a processor, one or more steps in the mapping method of the map engine described above may be implemented.

For example, the storage medium 40 may be applied in the above-described terminal device 30. For example, the storage medium 40 may be the memory 310 in the terminal device 30 illustrated in FIG. 3. For example, for the description of the storage medium 40, reference may be made to the corresponding description of the memory 310 in the terminal device 30 illustrated in FIG. 3, and details are not described herein again.

It should be understood that in the embodiments of the present disclosure, various portions may be implemented in hardware, software, firmware, or a combination thereof. In the above implementations, a plurality of steps or methods may be implemented by software or firmware that is stored in a memory and is executed by a suitable instruction execution system. For example, in a case where the hardware is used to implement the steps or methods, it can be implemented by using any of the following techniques known in the art or a combination thereof: a discrete logic circuit with logic gate circuits for implementing logic functions on data signals, an application specific integrated circuit with suitable combination logic gate circuits, a programmable gate array (PGA), a field programmable gate array (FPGA), and the like.

In addition, in the description of the present disclosure, an orientation or a positional relationship indicated by the terms such as “center,” “longitudinal,” “transverse,” “length,” “width,” “thickness,” “on,” “under,” “front,” “back,” “left,” “right,” “vertical,” “horizontal,” “top,” “bottom,” “inside,” “outside,” “clockwise,” “counterclockwise,” “axial,” “radial,” “circumferential,” etc., is based on the orientation or the positional relationship illustrated in the drawings, and is only for the convenience of describing the present disclosure and simplifying the description, but is not intended to indicate or imply that the device or component referred to must have a particular orientation or is constructed and operated in a particular orientation, and thus is not to be construed as limiting the present disclosure.

In addition, the terms “first,” “second,” etc., are used for descriptive purpose only and are not to be understood as indicating or implying a relative importance or implicitly indicating the number of the technical features indicated. Thus, features defined by “first” or “second” may explicitly or implicitly comprise at least one of the features. In the description of the present disclosure, the meaning of “a plurality” is at least two, such as two, three, etc., unless specifically defined otherwise.

In the present disclosure, the terms “installation,” “connected,” “connecting,” “fixed,” and the like, should be understood broadly, unless otherwise clearly defined and limited, for example, it can be a fixed connection, can also be a removable connection, or an integral; it can be a mechanical connection, but may also be an electrical connection; it can be a direct connection, can also be an indirect connection through an intermediate medium, and may be the internal communication of two components or an interaction relationship of two component, unless explicitly defined otherwise. Those skilled in the art can understand the specific meanings of the above terms in the present disclosure according to the specific situation.

In the present disclosure, unless otherwise clearly defined and limited, a first feature being “on” or “under” a second feature may indicate that the first feature and the second feature are in direct contact, or the first feature and the second feature are in indirect contact through an intermediate medium. Moreover, the first feature being “on,” “above,” or “over” the second feature may indicate that the first feature is right above or obliquely above the second feature, or only indicate that a horizontal height of the first feature is higher than a horizontal height of the second feature. The first feature being “under,” “below,” or “down” the second feature may indicate that the first feature is right below or obliquely below the second feature, or only indicate that a horizontal height of the first feature is lower than a horizontal height of the second feature.

In the description of the present disclosure, the description of reference terms such as “an embodiment,” “some embodiments,” “example,” “specific example,” or “some examples” means that the specific features, structures, materials, or characteristics described in conjunction with the embodiments or examples are included in at least one embodiment or example of the present disclosure. In the specification, the illustrative description of the above terms are not necessarily directed to the same embodiment or example. Moreover, the specific features, structures, materials, or characteristics described may be combined in a suitable manner in any one or more embodiments or examples. In addition, in a case of no contradictory, those skilled in the art can combine the different embodiments or examples and the features in the different embodiments or examples described in the specification.

Although the embodiments of the present disclosure have been illustrated and described above, it can be understood that the above-described embodiments are illustrative, and cannot be construed as limiting the present disclosure. Changes, modifications, alterations, and variations of the above-described embodiments may be made by those skilled in the art within the scope of the present disclosure.

What have been described above are only specific implementations of the present disclosure, and the protection scope of the present disclosure is not limited thereto. The protection scope of the present disclosure should be based on the protection scope of the claims.

1. A mapping method of a map engine, comprising:
receiving an instruction of a user; and
performing, according to the instruction of the user, a mapping operation corresponding to the instruction of the user in a drawing process of a surface view,
wherein the map engine comprises a map engine main process and the drawing process of the surface view.

2. The mapping method according to claim 1,
wherein, according to the instruction of the user, in the drawing process of the surface view, a plurality of layers are used to perform the mapping operation corresponding to the instruction of the user; and
the plurality of layers comprises a first layer and a second layer, the second layer is superimposed on the first layer, the second layer comprises information points, and a background of a region of the second layer except the information points is transparent.

3. The mapping method according to claim 1,
wherein the instruction of the user is received by the drawing process of the surface view or the map engine main process.

4. The mapping method according to claim 2, wherein the instruction of the user comprises one or a combination of several selected from a group comprising a scaling instruction, a translation instruction, a single-click instruction, a drawing instruction, a rotation instruction, and a skewing instruction.

5. The mapping method according to claim 4, wherein the instruction of the user is the drawing instruction, and
performing, according to the instruction of the user, the mapping operation corresponding to the instruction of the user in the drawing process of the surface view comprises:
determining, according to a type of a drawing message that is received, that the drawing instruction is an interface drawing instruction or a positioning information drawing instruction;
in a case of determining that the drawing instruction is the interface drawing instruction, performing path planning asynchronous drawing on the first layer; and
in a case of determining that the drawing instruction is the positioning information drawing instruction, performing positioning asynchronous drawing on the second layer.

6. The mapping method according to claim 5, wherein performing the path planning asynchronous drawing on the first layer comprises:
calling a path planning algorithm through a user interface calling interface; and
performing the path planning asynchronous drawing on the first layer according to the path planning algorithm.

7. The mapping method according to claim 5, wherein performing the positioning asynchronous drawing on the second layer comprises:
calling a positioning algorithm through a user interface calling interface; and
performing the positioning asynchronous drawing on the second layer according to the positioning algorithm.

8. The mapping method according to claim 4, wherein the instruction of the user is an enlargement instruction in the scaling instruction,
receiving the instruction of the user comprises:
in a case of detecting a double-click event of the user, determining that the enlargement instruction is received; and
performing, according to the instruction of the user, the mapping operation corresponding to the instruction of the user in the drawing process of the surface view comprises:
calculating a scaling ratio of a current map according to a scaling ratio of a map before the double-click event occurs and a preset magnification; and
performing a zoom-in operation on the map according to the scaling ratio of the current map.

9. The mapping method according to claim 4, wherein the instruction of the user is an enlargement instruction or a reduction instruction in the scaling instruction,
receiving the instruction of the user comprises:
in a case of detecting a multi-point-touch event of the user, determining that the enlargement instruction or the reduction instruction is received; and
performing, according to the instruction of the user, the mapping operation corresponding to the instruction of the user in the drawing process of the surface view comprises:
calculating a scaling ratio of a current multi-point-touch event according to a distance between two touch points in a last multi-point-touch event, a scaling ratio of the last multi-point-touch event, and a distance between two touch points in the current multi-point-touch event; and
performing a zoom-in operation or a zoom-out operation on a map according to the scaling ratio of the current multi-point-touch event.

10. The mapping method according to claim 4, wherein the instruction of the user is the translation instruction,
receiving the instruction of the user comprises:
in a case of detecting a single-point-drag event of the user, determining that the translation instruction is received; and
performing, according to the instruction of the user, the mapping operation corresponding to the instruction of the user in the drawing process of the surface view comprises:
calculating a center point of a current map according to a moving distance of a single touch point in the single-point-drag event and a center point of a map before the single-point-drag event occurs; and
performing a translation operation on the map according to the center point of the current map.

11. The mapping method according to claim 1, wherein performing, according to the instruction of the user, the mapping operation corresponding to the instruction of the user in the drawing process of the surface view comprises:
adjusting a position of a map mark according to a change in a center point of a map and a change in a scaling ratio of the map.

12. The mapping method according to claim 4, wherein the instruction of the user is the single-click instruction,
receiving the instruction of the user comprises:
in a case of detecting a single-click event of the user, determining that the single-click instruction is received;
performing, according to the instruction of the user, the mapping operation corresponding to the instruction of the user in the drawing process of the surface view comprises:
determining whether or not a position of a single touch point in the single-click event is located in a preset region of a map mark; and
in a case where the position of the single touch point in the single-click event is located in the preset region of the map mark, displaying a bitmap file of the map mark.

13. A mapping device of a map engine, comprising:
a receiving unit and a performing unit,
wherein the receiving unit is configured to receive an instruction of a user;
the performing unit is configured to perform, according to the instruction of the user, a mapping operation corresponding to the instruction of the user in a drawing process of a surface view; and
the map engine comprises a map engine main process and the drawing process of the surface view.

14. The mapping device according to claim 13,
wherein the performing unit is configured to adopt a plurality of layers to perform, according to the instruction of the user, the mapping operation corresponding to the instruction of the user in the drawing process of the surface view, and
the plurality of layers comprises a first layer and a second layer, the second layer is superimposed on the first layer, and a background of a region of the second layer except information points is transparent.

15. (canceled)

16. The mapping device according to claim 14, wherein the instruction of the user comprises one or a combination of several selected from a group comprising a scaling instruction, a translation instruction, a single-click instruction, a drawing instruction, a rotation instruction, and a skewing instruction.

17. The mapping device according to claim 16, wherein the instruction of the user is the drawing instruction, and
the performing unit is configured to determine, according to a type of a drawing message received by the receiving unit, that the drawing instruction is an interface drawing instruction or a positioning information drawing instruction, to perform path planning asynchronous drawing on the first layer in a case of determining that the drawing instruction is the interface drawing instruction, and to perform positioning asynchronous drawing on the second layer in a case of determining that the drawing instruction is the positioning information drawing instruction.

18. The mapping device according to claim 17, wherein the performing unit performing the path planning asynchronous drawing on the first layer comprises:
the performing unit calling a path planning algorithm through a user interface calling interface and performing the path planning asynchronous drawing on the first layer according to the path planning algorithm.

19. The mapping device according to claim 17, wherein the performing unit performing the positioning asynchronous drawing on the second layer comprises:
the performing unit calling a positioning algorithm through a user interface calling interface and performing the positioning asynchronous drawing on the second layer according to the positioning algorithm.

20-24. (canceled)

25. A terminal device, comprising:
a memory, a processor, and a computer program stored on the memory and being capable of being executed by the processor,
wherein the processor executes the computer program to implement the mapping method of the map engine according to claim 1.

26. A non-temporary computer readable storage medium on which a computer program is stored,
wherein the computer program is capable of being executed by a processor to implement the mapping method of the map engine according to claim 1.
